(19) United States
(12) Patent Application Publication
(10) Pub. No.: US 2025/0045110 A1
(43) Pub. Date: Feb. 6, 2025

(54) METHOD AND APPARATUS FOR PROCESSING TASK

(71) Applicant: SAMSUNG ELECTRONICS CO., LTD., Suwon-si (KR)

(72) Inventors: Wenlong LI, Nanjing (CN); Mengyuan WU, Nanjing (CN)

(73) Assignee: SAMSUNG ELECTRONICS CO., LTD., Suwon-si (KR)

(21) Appl. No.: 18/680,755

(22) Filed: May 31, 2024

Related U.S. Application Data
(63) Continuation of application No. PCT/KR2024/006627, filed on May 16, 2024.

(30) Foreign Application Priority Data
Aug. 4, 2023 (CN) 202310977546.1

(51) Int. Cl. G06F 9/50

(52) U.S. Cl. CPC G06F 9/5027

(57) ABSTRACT

Provided are an apparatus and method for processing a task. The method includes, based on receiving target information sent by a user terminal for a plurality of candidate applications in a group chat, performing semantic analysis on the target information to generate a target task corresponding to the target information. The method includes identifying, based on the target task and the plurality of candidate applications, a target application corresponding to the target task; providing the target task to the target application to execute the target task; receiving task result information corresponding to the target task. The method includes generating, based on the task result information, target response information corresponding to the task result information; providing the target response information corresponding to the task result information on the user terminal.

### CROSS-REFERENCE TO RELATED APPLICATION(S)

This application is a continuation application of International Application No. PCT/KR2024/006627, filed on May 16, 2024, which claims priority to Chinese Patent Application No. 202310977546.1, filed on Aug. 4, 2023, the disclosures of which are incorporated by reference herein in their entireties.

### BACKGROUND

### 1. Field

The disclosure relates to computer technology, and more particularly, to smart device control and information processing, and a method and apparatus for processing a task.

### 2. Description of Related Art

The number of applications in smart devices and functions thereof are increasing. Conventional interaction methods usually require users to perform multiple operations on interaction interfaces of smart devices, resulting in low interaction efficiency, poor interaction experience, and high learning cost due to the many differences in the interaction interfaces of different devices.

New interaction methods have emerged, but an interaction method of connecting and controlling smart devices through mobile applications requires users to download and install applications on mobiles and familiarize themselves with various operations of the applications, which has a high learning cost; while an interaction method of connecting smart devices through voice assistants only supports sending and receiving of voice or text, but does not support pictures, emoticons, videos, applets, etc., and it can only passively receive and execute instructions sent by users, and cannot actively push application messages, etc. to the users; and an interaction method of connecting smart devices through social software is limited by device control, i.e., it can only send control instructions to smart devices, but cannot perform more complex interactions with many applications on the smart devices, lacks awareness of user preferences and usage scenarios, and lacks permission management capabilities, and thus cannot easily set different interaction permissions for different users.

### SUMMARY

Provided are a method and apparatus for processing a task, an electronic device, and a computer readable medium.

According to an aspect of the disclosure, there is provided a method for processing a task, the method including: based on receiving target information sent by a user terminal for a plurality of candidate applications in a group chat, performing semantic analysis on the target information to generate a target task corresponding to the target information; identifying, based on the target task and the plurality of candidate applications, a target application corresponding to the target task; providing the target task to the target application to execute the target task; receiving task result information corresponding to the target task; generating, based on the task result information, target response information corresponding to the task result information; providing the target response information corresponding to the task result information on the user terminal.

The identifying the target application corresponding to the target task may include: identifying whether a task type of the target task is a preset type; based on identifying that the task type of the target task is the preset type, matching the target task with application information of the plurality of candidate applications to obtain a matching result; and identifying, based on the matching result, at least one target application corresponding to the target task from the plurality of candidate applications.

The providing the target task to the target application may include: acquiring a user identification corresponding to the user terminal; performing, based on permission information corresponding to the target application, permission verification on the user identification, to obtain a verification result of the user identification; and based on identifying that the verification result represents the user identification having permission, providing the target task to the target application.

The method further may further include: based on identifying that the verification result represents the user identification having no permission, generating permission restriction information corresponding to the target task based on the permission information of the target application; and providing the permission restriction information on the user terminal.

The method may further include: based on receiving permission setting information for a target terminal in the group chat, identifying a sending terminal corresponding to the permission setting information; and based on identifying that the sending terminal has setting permission, setting permission restriction information of the target terminal based on the permission setting information

The generating the target response information corresponding to the task result information may include: acquiring current environment information and a user identification corresponding to the user terminal; identifying portrait information corresponding to the target information, based on the user identification and the current environment information; and generating the target response information corresponding to the task result information, based on the portrait information corresponding to the target information.

The method may further include: based on identifying that a device is activated, acquiring application information of the plurality of candidate applications; creating a to-be-enabled group chat based on the application information of the plurality of candidate applications, and generating group chat information corresponding to the to-be-enabled group chat; and based on receiving an access operation sent by the user terminal based on the group chat information, joining the user terminal to the group chat.

The method may further include: based on receiving an access operation of a new terminal, identifying whether the access operation of the new terminal meets an access condition; and based on identifying that the access operation of the new terminal meets the access condition, joining the new terminal to the group chat.

The method may further include: based on receiving an add operation of the user terminal in the group chat, acquiring application information of a to-be-added application corresponding to the add operation; installing the to-be-added application based on the application information of the to-be-added application; and adding the application information of the to-be-added application to the group chat.

The method may further include: based on receiving a deletion operation of the user terminal in the group chat, acquiring application information of a to-be-deleted application corresponding to the deletion operation; uninstalling the to-be-deleted application based on the application information of the to-be-deleted application; and removing the application information of the to-be-deleted application from the group chat.

The performing the semantic analysis on the target information to generate the target task corresponding to the target information may include: based on receiving a plurality pieces of target information sent by a plurality of user terminals for the plurality of candidate applications in the group chat, performing semantic analysis on the plurality pieces of target information to generate a plurality of target tasks corresponding to the plurality pieces of target information, wherein the identifying the target application corresponding to the target task may include: sorting the plurality of target tasks according to pre-prioritization to obtain a task list; and identifying the target application corresponding to each target task successively, according to a sort sequence of the plurality of target tasks in the task list, and wherein the sending the target task to the target application may include: after processing of a target task is completed, providing a next target task to the corresponding target application, according to the sort sequence of the plurality of target tasks in the task list.

The method may further include: based on acquiring application notification information corresponding to the plurality of candidate applications, generating push information corresponding to the application notification information, based on a portrait information corresponding to the user terminal; and providing the push information on the user terminal.

According to an aspect of the disclosure, there is provided an apparatus for processing a task, the apparatus including: at least one memory configured to store instructions; at least one processor configured to execute the instructions to control the apparatus to: based on receiving target information sent by a user terminal for a plurality of candidate applications in a group chat, perform semantic analysis on the target information to generate a target task corresponding to the target information; identify a target application corresponding to the target task, based on the target task and the plurality of candidate applications; provide the target task to the target application, so that the target application executes the target task; receive task result information corresponding to the target task; generate, based on the task result information, target response information corresponding to the task result information; and provide the target response information corresponding to the task result information on the user terminal.

The at least one processor may be further configured to execute the instructions to control the apparatus to: identify whether a task type of the target task is a preset type; based on identifying that the task type of the target task is the preset type, match the target task with application information of the plurality of candidate applications to obtain a matching result; and identify, based on the matching result, at least one target application corresponding to the target task from the plurality of candidate applications.

The at least one processor may be further configured to execute the instructions to control the apparatus to: acquire a user identification corresponding to the user terminal; perform, based on permission information corresponding to the target application, permission verification on the user identification, to obtain a verification result of the user identification; and based on identifying that the verification result represents the user identification having permission, provide the target task to the target application.

The at least one processor may be further configured to execute the instructions to control the apparatus to: based on identifying that the verification result represents the user identification having no permission, generating permission restriction information corresponding to the target task based on the permission information of the target application; and providing the permission restriction information on the user terminal.

The at least one processor may be further configured to execute the instructions to control the apparatus to: based on receiving permission setting information for a target terminal in the group chat, identifying a sending terminal corresponding to the permission setting information; and based on identifying that the sending terminal has setting permission, setting permission restriction information of the target terminal based on the permission setting information.

The at least one processor may be further configured to execute the instructions to control the apparatus to: acquire current environment information and a user identification corresponding to the user terminal; identify portrait information corresponding to the target information, based on the user identification and the current environment information; and generate the target response information corresponding to the task result information, based on the portrait information corresponding to the target information.

According to an aspect of the disclosure, there is provided an electronic device, including: at least one processor; and at least one memory communicatively connected to the at least one processor, wherein the at least one memory is configured to store instructions that, when executed by the at least one processor, cause the electronic device to perform a method including: based on receiving target information sent by a user terminal for a plurality of candidate applications in a group chat, performing semantic analysis on the target information to generate a target task corresponding to the target information; identifying, based on the target task and the plurality of candidate applications, a target application corresponding to the target task; providing the target task to the target application to execute the target task; receiving task result information corresponding to the target task; generating, based on the task result information, target response information corresponding to the task result information; providing the target response information corresponding to the task result information on the user terminal.

According to an aspect of the disclosure, there is provided a non-transitory computer readable recording medium including instructions that, when executed, performs a method including: based on receiving target information sent by a user terminal for a plurality of candidate applications in a group chat, semantic analysis on the target information to generate a target task corresponding to the target information; determining, based on the target task and the plurality of candidate applications, a target application corresponding to the target task; providing the target task to the target application to execute the target task; receiving task result information corresponding to the target task; generating, based on the task result information, target response information corresponding to the task result information; and providing the target response information corresponding to the task result information on the user terminal.

According to the one or more embodiments, it is possible to interact with multiple candidate applications in a smart device through group chat, and a third-party chat application may be used to create a group chat, through which a user may send target information to the smart device, and the sending of content such as voice, text, pictures, emoticons, videos, or applets may be supported, improving the diversity of the sent content, and improving the efficiency of interaction.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example system architecture diagram to which one or more embodiments of the disclosure may be applied;

FIG. 2A illustrates a flowchart of a method for processing a task, according to one or more embodiments;

FIG. 2B illustrates a diagram of a user terminal sending target information for a group chat, according to one or more embodiments;

FIG. 2C illustrates a diagram of target response information, according to one or more embodiments;

FIG. 3 illustrates a flowchart for determining a target application corresponding to a target task, according to one or more embodiments;

FIG. 4A illustrates a flowchart for sending the target task to a target application, according to one or more embodiments;

FIG. 4B illustrates a diagram of permission restriction information, according to one or more embodiments;

FIG. 5A illustrates a flowchart for sending push information, according to one or more embodiments;

FIG. 5B illustrates a diagram of push information, according to one or more embodiments;

FIG. 6 illustrates a diagram of an apparatus for processing a task, according to one or more embodiments; and

FIG. 7 illustrates a diagram of an electronic device, according to one or more embodiments.

### DETAILED DESCRIPTION

The disclosure is described in further detail below in connection with the accompanying drawings and embodiments. It may be understood that the embodiments described herein are for the purpose of explaining the example embodiments, and are not a limitation of the disclosure. It should also be noted that, for ease of description, only parts related to the example embodiments are shown in the accompanying drawings.

The embodiments and features in the embodiments in the disclosure may be combined with each other on a non-conflict basis. The disclosure will be described in detail below with reference to the accompanying drawings and in connection with the embodiments.

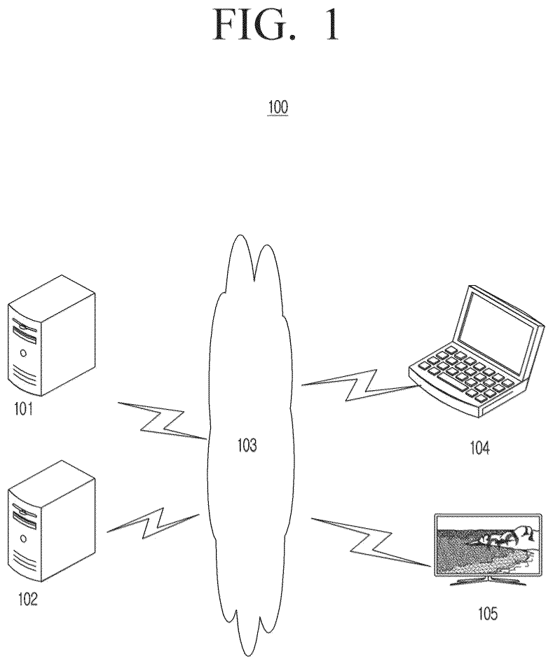

FIG. 1 illustrates an example system architecture 100 of a method for processing a task or an apparatus for processing a task, according to one or more embodiments.

As shown in FIG. 1, the system architecture 100 may include servers 101, 102, a network 103, and terminal devices 104, 105. The network 103 serves as a medium providing a communication link between the servers 101, 102, and the terminal devices 104, 105. The network 103 may include various types of connections, such as wired, wireless communication links or optical fibers.

A user may interact with the servers 101, 102 through the terminal devices 104, 105 using the network 103 to receive or send information or the like. Various applications may be installed on the terminal devices 104, 105, such as audio and video playback applications, or data processing applications.

The terminal devices 104, 105 may be hardware or software. When the terminal devices are hardware, they may be various electronic devices having displays and supporting communication with the servers, including but not limited to smartphones, tablet computers, laptop computers, desktop computers, or the like. When the terminal devices are software, they may be installed in the electronic devices listed above. The terminal devices may be implemented as a plurality of software or software modules, or as a single software or software module. However, the disclosure is not limited thereto.

One of the terminal devices 104, 105 may serve as a smart device being controlled, and the other may serve as a user terminal controlling the smart device. Thereby, the smart device in the terminal devices 104, 105 may receive target information sent by the user terminal for a plurality of candidate applications in a group chat, perform semantic analysis on the target information to generate a target task corresponding to the target information, then determine a target application corresponding to the target task based on the target task and the plurality of candidate applications, and then send the target task to the target application so that the target application executes the target task and returns task result information corresponding to the target task, and generate, based on the task result information, target response information corresponding to the task result information, and finally send the target response information corresponding to the task result information to the user terminal, so that the user terminal presents the target response information.

The servers 101, 102 may be servers that provide various services, such as a backend server that receives requests sent by a terminal device with which communication connection is established. The backend server may perform processing operations, such as receiving and analyzing the requests sent by the terminal device, and generate processing results.

The servers may be hardware or software. When the servers are hardware, they may be various electronic devices providing various services for the terminal devices. When the servers are software, they may be implemented as a plurality of software or software modules providing various services for the terminal devices, or may be implemented as a single software or software module providing various services for the terminal devices. However, the disclosure is not limited thereto.

The method for processing a task provided by embodiments of the disclosure may be performed by the terminal devices 104, 105. Accordingly, the apparatus for processing a task is provided in the terminal devices 104, 105.

It should be understood that the number of servers, networks, and playback devices in FIG. 1 is merely illustrative. There may be any number of playback devices, networks, and servers based on implementation needs.

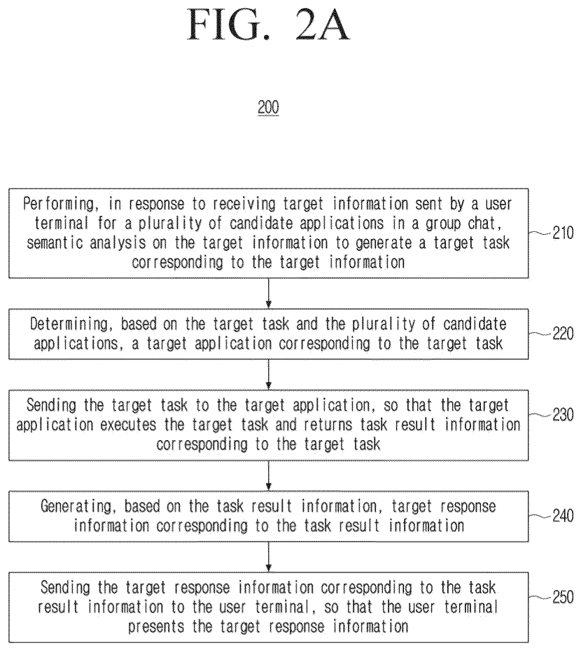

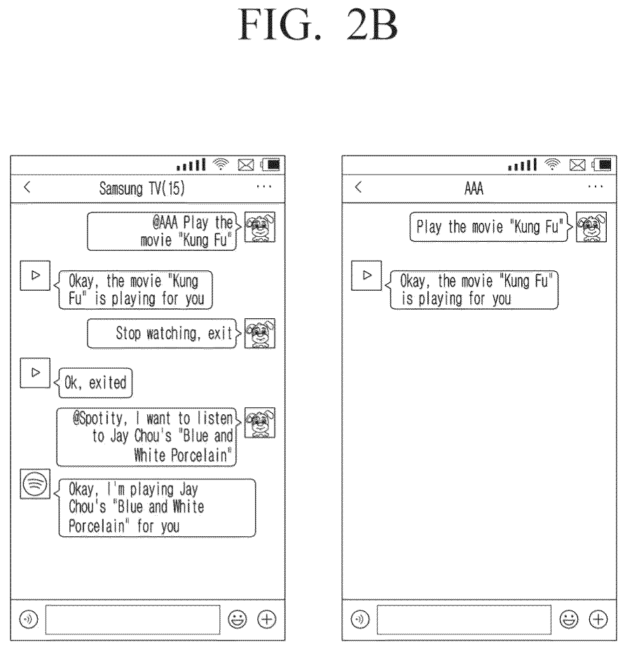

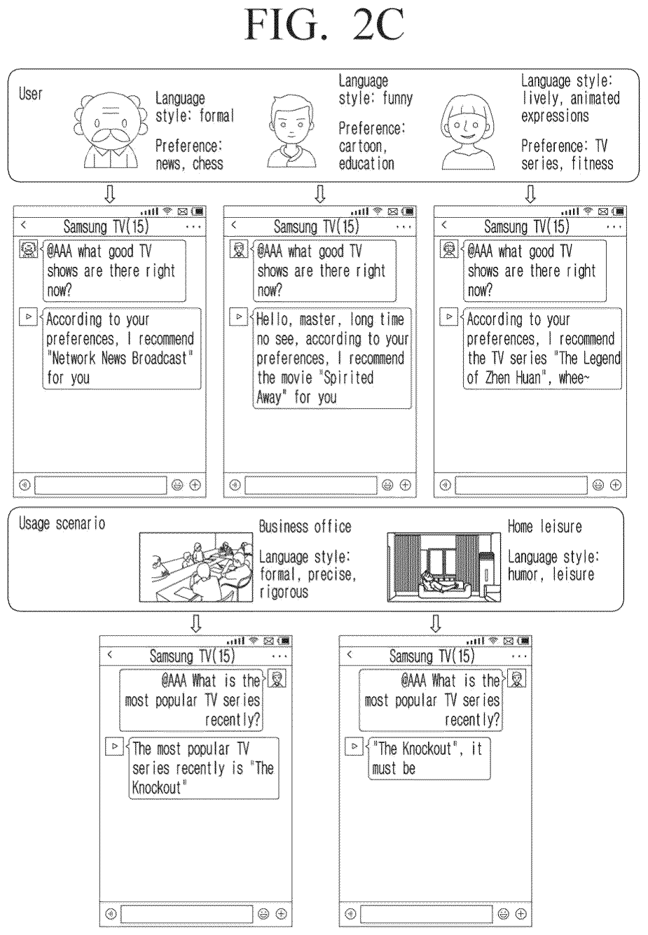

Referring to FIG. 2A, a flow 200 of a method for processing a task, according to one or more embodiments, is illustrated. The method for processing a task may include the following operations.

In operation 210, in response to receiving target information sent by a user terminal for a plurality of candidate applications in a group chat, semantic analysis may be performed on the target information to generate a target task corresponding to the target information.

An executing body (e.g., the terminal devices 104 and 105 shown in FIG. 1) of the above method for processing a task may be connected to the user terminal via a network connection or via a cloud-based social service, and the group chat is created between the executing body and the user terminal. The group chat includes the user terminal and the plurality of candidate applications in the executing body. A user may input the target information, which may be control information for the candidate applications in the group chat, for the plurality of candidate applications in the group chat by the user terminal. The user may input the target information, for the candidate applications in the group chat by the user terminal, and may also input the target information for the candidate applications in the form of a private chat by the user terminal. For example, FIG. 2C illustrates a user inputting target information for candidate applications in a group chat via both a group chat and a private chat.

The executing body may receive, via the network connection or via the cloud-based social service, the target information sent by the user terminal for the plurality of candidate applications in the group chat, perform semantic analysis on the received target information, determine a user intent corresponding to the target information, and generate the target task corresponding to the target information based on a semantic analysis result.

In operation 220, a target application corresponding to the target task may be determined, based on the target task and the plurality of candidate applications.

After generating the target task, the executing body may analyze the target task to determine task content corresponding to the target task. The executing body may then determine, based on the task content, whether the task content is a task for a plurality of local candidate applications, or a task for a cloud-based third-party service application.

If it is determined that the target task is a task for the plurality of local candidate applications, the executing body may determine the target application corresponding to the target task from the plurality of candidate applications based on the task content.

If it is determined that the target task is a task for the cloud-based third-party service application, the executing body may determine the target application corresponding to the target task from a plurality of cloud-based third-party service applications based on the task content.

In operation 230, the target task may be sent to the target application, so that the target application executes the target task and returns task result information corresponding to the target task.

After determining the target application corresponding to the target task, the executing body may send the target task to the target application. After receiving the target task, the target application starts executing the target task based on the task content of the target task, and after executing the target task, returns to the executing body the task result information corresponding to the target task. The task result information may be an execution result and feedback information fed back by the target application after executing the target task.

In operation 240, target response information corresponding to the task result information may be generated, based on the task result information.

After receiving the task result information corresponding to the target task, the executing body may perform semantic analysis and statement generation on the task result information to generate the target response information corresponding to the task result information. The target response information may represent the execution result and the feedback information of the target application for the target task.

In operation 250, the target response information corresponding to the task result information may be sent to the user terminal, so that the user terminal presents the target response information.

After generating the target response information, the executing body may send the target response information corresponding to the task result information to the user terminal. After receiving the target response information, the user terminal may present the target response information via a screen in a group chat interface or a private chat interface. The target response information may include text, emoticons, images, or the like, which is not limited in the disclosure in this regard.

The method for processing a task provided by the above embodiment of the disclosure is implemented by performing, in response to receiving target information sent by a user terminal for a plurality of candidate applications in a group chat, semantic analysis on the target information to generate a target task corresponding to the target information; then determining a target application corresponding to the target task, based on the target task and the plurality of candidate applications; sending the target task to the target application, so that the target application executes the target task and returns task result information corresponding to the target task; generating, based on the task result information, target response information corresponding to the task result information; and finally sending the target response information corresponding to the task result information to the user terminal, so that the user terminal presents the target response information, and thus it is possible to interact with multiple candidate applications in a smart device through group chat, a third-party chat application may be used to create a group chat, through which a user may send target information to the smart device, and the sending of content such as voice, text, pictures, emoticons, videos, or applets may be supported, thereby improving the diversity of the sent content, and improving the fun and efficiency of interaction.

In an embodiment, operation 240, i.e., the generating, based on the task result information, target response information corresponding to the task result information, may include the following operations.

First, current environment information and a user identification corresponding to the user terminal may be acquired.

The executing body may acquire the user identification corresponding to the user terminal and the current environment information, where the user identification may represent user identity information corresponding to the user terminal, and the current environment information may represent geographic location information and language environment information, etc. of the user terminal while sending the target information.

The collection, gathering, updating, analyzing, processing, usage, transmitting, and storage of user personal information involved in the technical solution of the disclosure comply with relevant laws and regulations, are used for lawful purposes, and do not violate public order and morals. Necessary measures are taken for user personal information, so as to prevent illegal access to user personal information data, and to maintain the security of user personal information, network security and national security.

Second, portrait information corresponding to the target information may be determined, based on the user identification and the current environment information.

The executing body may acquire corresponding historical chat information and user information based on the user identification, and determine portrait information representing the user's preference and language style based on at least one of the historical chat information, the user information and/or the current environment information. Different user terminals may correspond to different portrait information, so that the target information sent by the different user terminals may correspond to different portrait information.

Third, the target response information corresponding to the task result information may be generated, based on the portrait information corresponding to the target information.

After acquiring the portrait information corresponding to the target information, the executing body may, based on the portrait information, perform semantic analysis and statement generation on the task result information to generate target response information that matches the portrait information, wherein different portrait information may correspond to different target response information.

As an example, FIG. 2C illustrates that for the same piece of target information, the portrait information of different user terminals may correspond to different target response information. For example, a first piece of portrait information is “Language style: formal; Preference: news, chess”; a second piece of portrait information is “Language style: funny; Preference: cartoon, education”; a third piece of portrait information is “Language style: lively, animated expressions; Preference: TV series, fitness”; alternatively, different usage scenarios correspond to different portrait information, thus may correspond to different target response information, e.g., a fourth piece of portrait information is “Business office; Language style: formal, precise, rigorous”; a fifth piece of portrait information is “Home leisure; Language style: humor, leisure”, then each piece of portrait information may correspond to a piece of target response information.

In this implementation, by generating personalized responses based on information such as user preferences, geographic location, and sending the corresponding target response information to the user terminal based on the portrait information, personalized responses and anthropomorphic interactions for the target task may be realized, which improves an accuracy of the target response information, and improves the fun and efficiency of interaction.

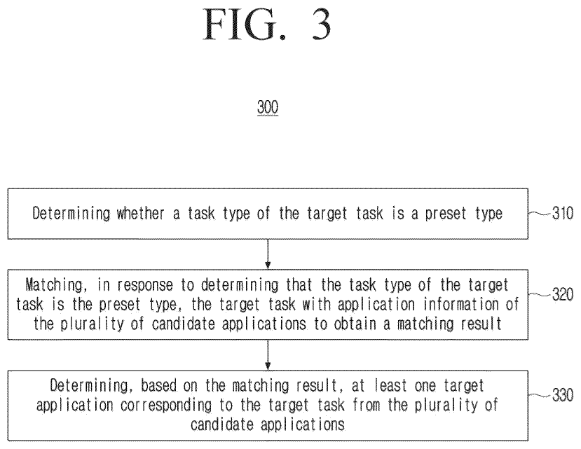

Referring to FIG. 3, a flowchart 300 of determining a target application corresponding to a target task (that is, operation 220 of FIG. 2, i.e., the determining a target application corresponding to the target task, based on the target task and the plurality of candidate applications) is illustrated, and it may include the following operations.

In operation 310, it may be determined whether a task type of the target task is a preset type.

After generating the target task, the executing body may judge the task type of the target task to determine whether the task type of the target task is the preset type. The preset type may be a broadcasting task type for the plurality of candidate applications at the same time.

In operation 320, in response to determining that the task type of the target task is the preset type, the target task with application information of the plurality of candidate applications may be determined to obtain a matching result.

If it is determined through the judgment that the task type of the target task is the preset type, the executing body may match the target task with the application information of the plurality of candidate applications, and based on the task content of the target task, the executing body may respectively match it with content of the application information of each candidate application, find at least one candidate application that conforms to the task content, and determine the candidate application that conforms to the task content as the matching result.

In operation 330, at least one target application corresponding to the target task from the plurality of candidate applications may be determined, based on the matching result.

After obtaining the matching result, the executing body may determine the at least one target application corresponding to the target task from the plurality of candidate applications based on the at least one candidate application in the matching result.

As an example, if there are a plurality of target applications, a best matching target application may be determined based on preset matching rules, such as usage frequency priority, or user preference priority, and then the target task may be sent to the best matching target application.

As an example, if there are a plurality of target applications, the target task may be sent directly to all of the target applications.

If it is determined through judgment that the task type of the target task is not the preset type, the executing body may determine whether the task content is a task for a plurality of local candidate applications or a task for a cloud-based third-party service application based on the task content of the target task. If it is determined that the target task is a task for the plurality of local candidate applications, the executing body may determine the target application corresponding to the target task from the plurality of candidate applications based on the task content. If it is determined that the target task is a task for the cloud-based third-party service application, the executing body may determine the target application corresponding to the target task from a plurality of cloud-based third-party service applications based on the task content.

In an embodiment, by performing type judgment on the task type of the target task and performing different steps or operations for different task types, different target applications may be determined for the target task of the broadcasting task type, which improves the pertinence of the task, thereby improving an accuracy of processing the target task.

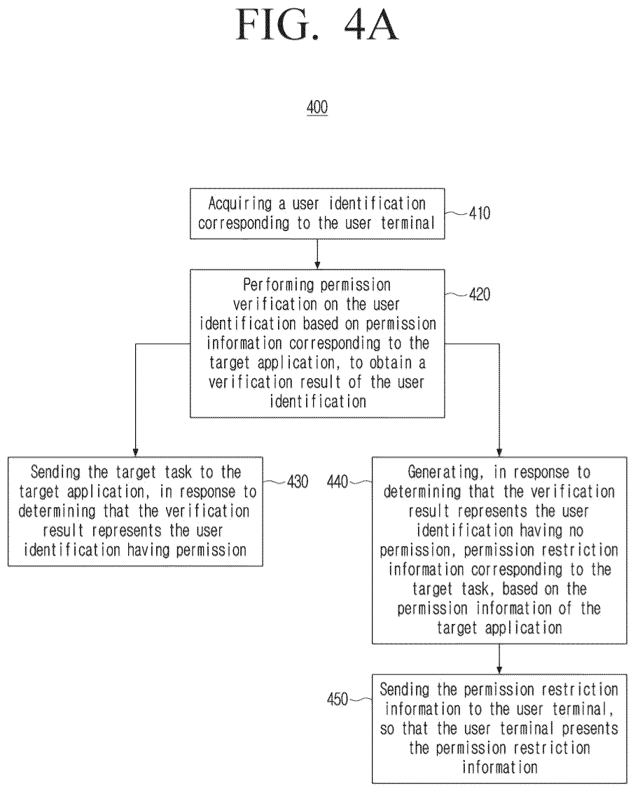

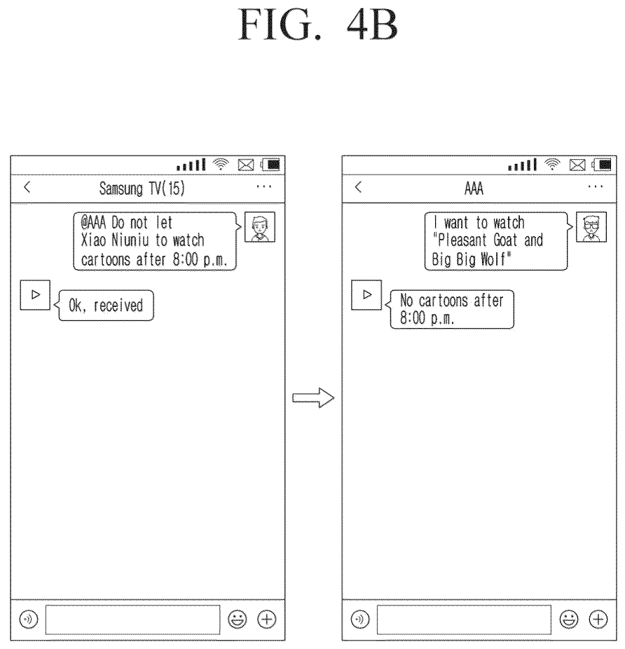

Referring to FIG. 4A, a flowchart 400 of an embodiment of sending the target task to a target application (that is, operation 230 of FIG. 2, i.e., sending the target task to the target application) is illustrated, and it may include the following steps:

In operation 410, a user identification corresponding to the user terminal may be acquired.

After determining the target application, the executing body may further acquire the user identification corresponding to the user terminal, and the user identification may represent user identity information corresponding to the user terminal.

In operation 420, permission verification on the user identification may be performed based on permission information corresponding to the target application, to obtain a verification result of the user identification.

The executing body may acquire the permission information corresponding to the target application. The permission information may be restriction information for use of the target application by a certain user terminal, and the permission information may be information preset by a user terminal having the highest permission among multiple user terminals in a group chat. Then, the executing body may perform permission verification on the user identification based on the permission information corresponding to the target application, determine whether the user terminal corresponding to the user identification has permission to control the target application, and obtain the verification result of the user identification.

In operation 430, sending the target task to the target application, in response to determining that the verification result represents the user identification having permission.

If it is determined through permission verification that the verification result represents the user identification having permission, the executing body may send the target task directly to the target application.

In an embodiment, by performing permission verification on the user identification to determine whether the user has the permission to control the target application, application control is more accurate, and the accuracy and pertinence of device control may be improved.

In operation 440, in response to determining that the verification result represents the user identification having no permission, permission restriction information corresponding to the target task may be generated, based on the permission information of the target application.

If it is determined through permission verification that the verification result represents the user identification having no permission, the executing body may generate the permission restriction information corresponding to the target task, based on the permission information of the target application and the portrait information.

In operation 450, the permission restriction information may be sent to the user terminal, so that the user terminal presents the permission restriction information.

After generating the permission restriction information, the executing body may send the permission restriction information to the user terminal, so that the user terminal presents the permission restriction information.

For example, FIG. 4B illustrates a diagram of permission restriction information of the disclosure, where the permission information of the target application is “do not let Xiao Niuniu to watch cartoons after 8:00 p.m.”, and the generated permission restriction information may be “No cartoons after 8:00 p.m.”.

In an embodiment, by performing permission verification on the user identification to determine whether the user has the permission to control the target application, in the case that the user does not have permission, the target application cannot be controlled, so that application control is more accurate, and the accuracy and pertinence of device control may be improved.

In an embodiment, the method for processing a task may further include: determining, in response to receiving permission setting information for a target terminal in the group chat, a sending terminal corresponding to the permission setting information; and setting, in response to determining that the sending terminal has setting permission, permission restriction information of the target terminal, based on the permission setting information.

The group chat may include a plurality of user terminals, and the setting permission of the plurality of user terminals are not the same, for example, a first user terminal that joins the group chat has the highest setting permission, and may control all members of the group chat; the setting permissions of user terminals that are added subsequently are lower than the setting permission of the first user terminal, and the first user terminal may perform an operation of setting permission for the other user terminals in the group chat, restricting use permission of the other user terminals, and so on. The executing body may receive the permission setting information for the target terminal in the group chat. The target terminal may be a user terminal other than the user terminal having the highest permission. The permission setting information may be setting information for permission restriction on the target terminal, and may include information that restricts the target terminal's use of a certain candidate application, or restricts the target terminal's use of a certain type of candidate application, or restricts the target terminal's use of a certain candidate application in a certain period of time, or restricts the target terminal's permission to add operations and delete operations, etc. For example, the permission setting information may be “do not let Xiao Niuniu to watch cartoons after 8:00 p.m.”, then the executing body may further determine the sending terminal corresponding to the permission setting information, and the sending terminal may be a user terminal that sends the permission setting information.

Then, the executing body may judge the permission of the sending terminal to determine whether the sending terminal has the setting permission, for example, it may make judgment through a terminal identification of the sending terminal to determine whether the terminal identification corresponds to the user terminal having the highest permission. If it is determined through judgment that the sending terminal has the setting permission, the permission restriction information of the target terminal may be set based on the permission setting information.

In this implementation, by performing permission setting on the user terminals in the group chat, user permissions may be managed, different application operation permissions may be set for different user terminals, and specific users may be prohibited from accessing specific applications, which improves the diversity and flexibility of permission setting.

In an embodiment, the method for processing a task may further include: acquiring, in response to determining that a device is activated, application information of a plurality of candidate applications; creating a to-be-enabled group chat based on the application information of the plurality of candidate applications, and generating group chat information corresponding to the group chat to-be-enabled; and making the user terminal join in the group chat, in response to receiving an access operation sent by the user terminal based on the group chat information.

After the executing body is activated, it may acquire the application information of the plurality of candidate applications, create the to-be-enabled group chat based on the application information of the plurality of candidate applications, and generate the group chat information corresponding to the group chat to-be-enabled, and the group chat information may include QR code information. The user terminal may read the group chat information and send the access operation to the executing body based on the group chat information corresponding to the group chat to-be-enabled. Then, after receiving the access operation sent by the user terminal based on the group chat information, the executing body may make the user terminal join in the group chat, realizing connection between the executing body and the user terminal.

In this implementation, by creating the group chat based on the application information of the plurality of candidate applications, and for the user terminal to join the group chat based on the group chat information, the connection between the user terminal and the smart device is realized, so that the user may control the applications in the smart device in the group chat by way of chatting, which improves the flexibility of controlling the smart device.

In an embodiment, the method for processing a task may further include: determining, in response to receiving an access operation of a new terminal, whether the access operation of the new terminal meets an access condition; and make the new terminal join in the group chat, in response to determining that the access operation of the new terminal meets the access condition.

The executing body may receive the access operation of the new terminal and make judgment on the access operation of the new terminal to determine whether the access operation of the new terminal meets the access condition. The access condition may be that the access way of the new terminal is being invited to join the group chat by a user terminal that has already joined the group chat. After determining through judgment that the access operation of the new terminal meets the access condition, the executing body may make the new terminal join in the group chat, realizing connection between the executing body and the new terminal.

In this implementation, by judging the access operation of the new terminal based on the access condition, the connection between the new terminal and the smart device is realized, so that the access of the new terminal is more accurate, thereby improving the accuracy of controlling the smart device.

In an embodiment, the method for processing a task may further include: acquiring, in response to receiving an add operation of the user terminal in the group chat, application information of a to-be-added application corresponding to the add operation; installing the to-be-added application based on the application information of the to-be-added application; and adding the application information of the to-be-added application to the group chat.

The user may perform an add operation for the application in the group chat by the user terminal, and the executing body may receive the add operation of the user terminal in the group chat and determine the application information of the corresponding to-be-added application based on the add operation. Then, the executing body may determine, based on the application information of the to-be-added application, the to-be-added application corresponding to the application information and install the to-be-added application. After determining that the to-be-added application has been installed, the executing body may add the application information of the to-be-added application to the group chat, thereby making a new group member join in the group chat.

In this implementation, by receiving the add operation of the user terminal in the group chat, a new application is installed and the new application is added to the group chat, so that the applications on the smart device can be managed based on a group member management function in the group chat, which facilitates installation of the applications by the user and improves the flexibility of device management.

In an embodiment, the method for processing a task may further include: acquiring, in response to receiving a deletion operation of the user terminal in the group chat, application information of a to-be-deleted application corresponding to the deletion operation; uninstalling the to-be-deleted application based on the application information of the to-be-deleted application; and removing the application information of the to-be-deleted application from the group chat.

The user may perform a deletion operation for the application in the group chat by the user terminal, and the executing body may receive the deletion operation of the user terminal in the group chat and determine the application information of the corresponding to-be-deleted application based on the deletion operation. Then, the executing body may determine, based on the application information of the to-be-deleted application, the to-be-deleted application corresponding to the application information and uninstall the to-be-deleted application. After determining that the to-be-deleted application has been uninstalled, the executing body may remove the application information of the to-be-deleted application from the group chat, thereby removing a group member from the group chat.

In this implementation, by receiving the deletion operation of the user terminal in the group chat, the application is uninstalled and the application is deleted from the group chat, so that the applications on the smart device can be managed based on the group member management function in the group chat, which facilitates uninstallation of the applications by the user and improves the flexibility of device management.

In an embodiment, the method for processing a task may further include: performing, in response to receiving a plurality pieces of target information sent by a plurality of user terminals for the plurality of candidate applications in the group chat, semantic analysis on the plurality pieces of target information to generate a plurality of target tasks corresponding to the plurality pieces of target information; sorting the plurality of target tasks according to pre-prioritization to obtain a task list; and determining the target application corresponding to each target task successively, according to a sort sequence of the plurality of target tasks in the task list; after processing of a target task is completed, sending a next target task to the corresponding target application, according to the sort sequence of the plurality of target tasks in the task list.

The executing body may receive the plurality pieces of target information sent by the plurality of user terminals for the plurality of candidate applications in the group chat, perform semantic analysis on the plurality pieces of target information to generate the plurality of target tasks corresponding to the plurality pieces of target information. Then, the executing body may organize the tasks according to the pre-prioritization, sort the plurality of target tasks to obtain the task list. The pre-prioritization may be a priority corresponding to each user terminal, then different user terminals may correspond to different priorities. Therefore, the executing body may sort the plurality of target tasks according to the priorities corresponding to the plurality of user terminals to obtain the task list.

After obtaining the task list, the executing body may determine the target application corresponding to each target task successively, according to the sort sequence of the plurality of target tasks in the task list, and prioritize the execution of a target task corresponding to a user terminal having high priority according to the sort sequence of the plurality of target tasks, and after the processing of a target task is completed, send a next target task to the corresponding target application, according to the sort sequence of the plurality of target tasks in the task list.

In this implementation, by performing task organization on the target tasks corresponding to the plurality of user terminals, multi-user interaction can be supported, and a plurality of target tasks are executed according to different priorities, which improves the pertinence and flexibility of task processing, thereby improving the accuracy of device management.

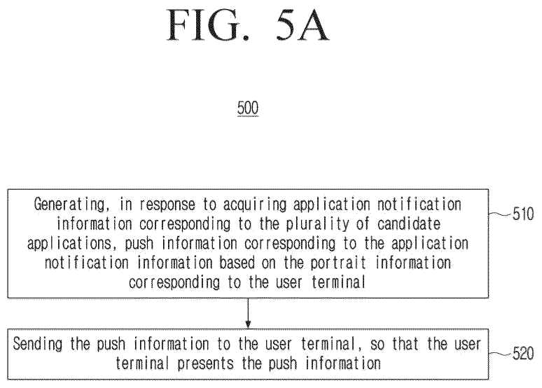

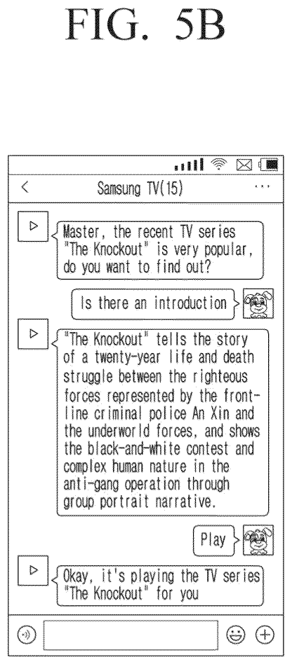

FIG. 5A illustrates a flowchart 500 of sending push information according to one or more embodiments.

In 510, in response to acquiring application notification information corresponding to the plurality of candidate applications, push information corresponding to the application notification information may be generated based on the portrait information corresponding to the user terminal.

The executing body may acquire the application notification information corresponding to the plurality of candidate applications and acquire the portrait information corresponding to the user terminal. The executing body may perform, based on the portrait information corresponding to the user terminal, semantic analysis and statement generation on the application notification information to generate the push information that conforms to the portrait information, where different portrait information may correspond to different push information.

In operation 520, the push information may be sent to the user terminal, so that the user terminal presents the push information.

The executing body may send the push information to the user terminal, so that the user terminal may present the push information in the group chat via a screen, and the user may view the push information via the user terminal and send information in the group chat. As an example, FIG. 5B illustrates a diagram of a user terminal presenting push information.

In an embodiment, the application notification information is converted into push information that conforms to a style of the user by using the portrait information, and the relevant application notification information is pushed to the user in time, which improves the accuracy and diversity of information pushing.

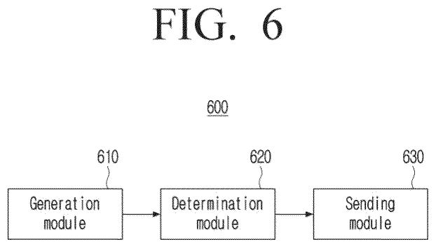

With further reference to FIG. 6, as an implementation of the method shown in the above figures, the disclosure provides an embodiment of an apparatus for processing a task, the embodiment of the apparatus corresponds to the embodiment of the method shown in FIG. 2, and the apparatus may be applied in various electronic devices.

As shown in FIG. 6, the apparatus 600 for processing a task in an embodiment includes: a generation module 610, a determination module 620 and a sending module 630.

The generation module 610 is configured to perform, in response to receiving target information sent by a user terminal for a plurality of candidate applications in a group chat, semantic analysis on the target information to generate a target task corresponding to the target information.

The determination module 620 is configured to determine a target application corresponding to the target task, based on the target task and the plurality of candidate applications.

The sending module 630 is configured to send the target task to the target application, so that the target application executes the target task and returns task result information corresponding to the target task.

The generation module 610 is configured to generate, based on the task result information, target response information corresponding to the task result information.

The sending module 630 is configured to send the target response information corresponding to the task result information to the user terminal, so that the user terminal presents the target response information.

In an embodiment, the determination module 620 is further configured to: determine whether a task type of the target task is a preset type; match, in response to determining that the task type of the target task is the preset type, the target task with application information of the plurality of candidate applications to obtain a matching result; and determine, based on the matching result, at least one target application corresponding to the target task from the plurality of candidate applications.

In an present embodiment, the sending module 630 is further configured to: acquire a user identification corresponding to the user terminal; perform permission verification on the user identification based on permission information corresponding to the target application, to obtain a verification result of the user identification; and send the target task to the target application, in response to determining that the verification result represents the user identification having permission.

In an embodiment, the sending module 630 is further configured to: generate, in response to determining that the verification result represents the user identification having no permission, permission restriction information corresponding to the target task, based on the permission information of the target application; and send the permission restriction information to the user terminal, so that the user terminal presents the permission restriction information.

In an embodiment, the apparatus further includes a setting module, and the setting module is configured to: determine, in response to receiving permission setting information for a target terminal in the group chat, a sending terminal corresponding to the permission setting information; and set, in response to determining that the sending terminal has setting permission, permission restriction information of the target terminal, based on the permission setting information.

In an embodiment, the generation module 610 is further configured to: acquire current environment information and a user identification corresponding to the user terminal; determine portrait information corresponding to the target information, based on the user identification and the current environment information; and generate the target response information corresponding to the task result information, based on the portrait information corresponding to the target information.

In an embodiment, the apparatus further includes a joining module, and the joining module is configured to: acquire, in response to determining that a device is activated, application information of the plurality of candidate applications; create a to-be-enabled group chat based on the application information of the plurality of candidate applications, and generate group chat information corresponding to the group chat to-be-enabled; and make the user terminal join in the group chat, in response to receiving an access operation sent by the user terminal based on the group chat information.

In an embodiment, the joining module is further configured to: determine, in response to receiving an access operation of a new terminal, whether the access operation of the new terminal meets an access condition; and make the new terminal join in the group chat, in response to determining that the access operation of the new terminal meets the access condition.

In an embodiment, the apparatus further includes an adding module, and the adding module is configured to: acquire, in response to receiving an add operation of the user terminal in the group chat, application information of a to-be-added application corresponding to the add operation; install the to-be-added application based on the application information of the to-be-added application; and add the application information of the to-be-added application to the group chat.

In an embodiment, the apparatus further includes a deletion module, and the deletion module is configured to: acquire, in response to receiving a deletion operation of the user terminal in the group chat, application information of a to-be-deleted application corresponding to the deletion operation; uninstall the to-be-deleted application based on the application information of the to-be-deleted application; and remove the application information of the to-be-deleted application from the group chat.

In an embodiment, the generation module 610 is further configured to perform, in response to receiving a plurality pieces of target information sent by a plurality of user terminals for the plurality of candidate applications in the group chat, semantic analysis on the plurality pieces of target information to generate a plurality of target tasks corresponding to the plurality pieces of target information, the determination module 620 is further configured to sort the plurality of target tasks according to pre-prioritization to obtain a task list, and determine the target application corresponding to each target task successively according to a sort sequence of the plurality of target tasks in the task list, and the sending module 630 is further configured to send, after processing of a target task is completed, a next target task to the corresponding target application, according to the sort sequence of the plurality of target tasks in the task list.

In an embodiment, the apparatus further includes a push module; and the push module is configured to: generate, in response to acquiring application notification information corresponding to the plurality of candidate applications, push information corresponding to the application notification information, based on the portrait information corresponding to the user terminal; and send the push information to the user terminal, so that the user terminal presents the push information.

The apparatus for processing a task provided by the above embodiment of the disclosure is implemented by performing, in response to receiving target information sent by a user terminal for a plurality of candidate applications in a group chat, semantic analysis on the target information to generate a target task corresponding to the target information; then determining a target application corresponding to the target task, based on the target task and the plurality of candidate applications; sending the target task to the target application, so that the target application executes the target task and returns task result information corresponding to the target task; generating, based on the task result information, target response information corresponding to the task result information; and finally sending the target response information corresponding to the task result information to the user terminal so that the user terminal presents the target response information, and thus it is possible to interact with multiple candidate applications in a smart device through group chat, and a third-party chat application may be used to create a group chat, through which a user may send target information to the smart device, the sending of content such as voice, text, pictures, emoticons, videos, or applets may be supported, thereby improving the diversity of the sent content, and improving the fun and efficiency of interaction.

It may be appreciated by those skilled in the art that the above apparatus further includes some other well-known structures, such as processors, or memories, in order to not unnecessarily obscure embodiments of the disclosure, these well-known structures are not shown in FIG. 6.

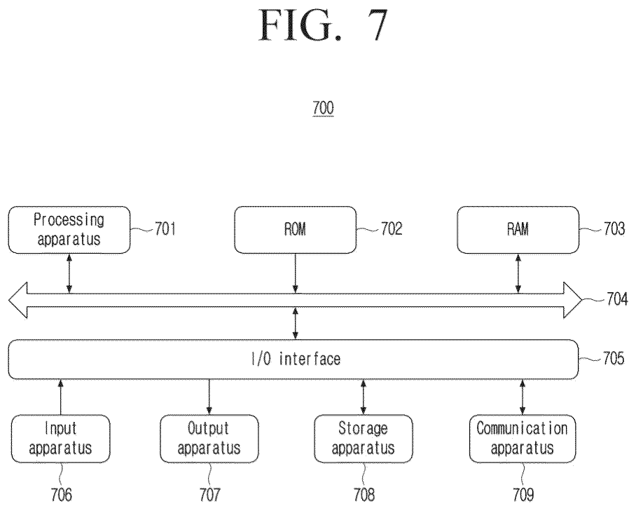

With further reference to FIG. 7, a diagram of an electronic device (e.g., the server in FIG. 1) 700 suitable for implementing embodiments of the disclosure is illustrated.

As shown in FIG. 7, the electronic device 700 may include a processing apparatus (for example, a central processing unit, a graphics processor, etc.) 701, which may execute various appropriate actions and processes in accordance with a program stored in a read-only memory (ROM) 702 or a program loaded into a random access memory (RAM) 703 from a storage apparatus 708. In the RAM 703, various programs and data required for the operation of the electronic device 700 are also stored. The processing apparatus 701, the ROM 702, and the RAM 703 are connected to each other through a bus 704. An input/output (I/O) interface 705 is also connected to the bus 704.

The following apparatuses may be connected to the I/O interface 705: an input apparatus 706 including such as a touch screen, a touch pad, a keyboard, a mouse, a camera, a microphone, an accelerometer, or a gyroscope; an output apparatus 707 including such as a liquid crystal display (LCD), a speaker, a vibrator; the storage apparatus 708 including such as a magnetic tape, a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all the illustrated apparatuses. It may alternatively be implemented or provided with more or fewer apparatuses. Each block shown in FIG. 7 may represent one apparatus, or may represent a plurality of apparatuses as needed.

According to one or more embodiments of the disclosure, the process described above with reference to the flowchart may be implemented as a computer software program. For example, embodiments of the disclosure include a computer program product comprising a computer program embodied on a computer readable medium, the computer program comprises program code for performing the method shown in the flowchart. In such an embodiment, the computer program may be downloaded and installed from the network through the communication apparatus 709, or installed from the storage apparatus 708, or installed from the ROM 702. When the computer program is executed by the processing apparatus 701, the above functions defined in the method of the embodiment of the disclosure are performed.

The computer-readable medium described in the embodiments of the disclosure may be a computer-readable signal medium or a computer-readable storage medium or any combination thereof. The computer-readable storage medium may be, for example, but not limited to, an electrical, magnetic, optical, electromagnetic, infrared, or semiconductor system, an apparatus, or a device, or any combination of the above. More specific examples of the computer-readable storage medium may include, but are not limited to, an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing. In embodiments of the disclosure, the computer-readable storage medium may be any tangible medium containing or storing a program for use by or in connection with an instruction execution system, an apparatus, or a device. In embodiments of the present disclosure, the computer-readable signal medium may comprise data signals propagated in baseband or as part of a carrier wave, which carry computer-readable program code. Such propagated data signals may be in a variety of forms including, but not limited to, electromagnetic signals, optical signals, or any suitable combination of the foregoing. The computer-readable signal medium may also be any computer-readable medium other than a computer-readable storage medium, and the computer-readable signal medium may dispatch, propagate, or transmit a program for use by or in connection with an instruction execution system, an apparatus, or a device. The program code embodied on the computer readable medium may be transmitted using any suitable medium, including, but not limited to, wires, optical cables, RF (radio frequency), and the like, or any suitable combination thereof.

The above computer readable medium may be included in the electronic device, or may also be present alone and not assembled into the electronic device. The computer readable medium carries one or more programs. The one or more programs, when executed by the electronic device, cause the electronic device to: perform, in response to receiving target information sent by a user terminal for a plurality of candidate applications in a group chat, semantic analysis on the target information to generate a target task corresponding to the target information; determine a target application corresponding to the target task, based on the target task and the plurality of candidate applications; send the target task to the target application, so that the target application executes the target task and returns task result information corresponding to the target task; generate, based on the task result information, target response information corresponding to the task result information; and send the target response information corresponding to the task result information to the user terminal, so that the user terminal presents the target response information.

The computer program code for performing the operations of embodiments of the disclosure may be written in one or more programming languages, or combinations thereof, the programming languages include object-oriented programming languages such as Java, Smalltalk, C++, and also include conventional procedural programming languages such as C language or similar programming language. The program code may be executed entirely or partly on the user computer, executed as a separate software package, executed partly on the user computer and partly on the remote computer, or executed entirely on the remote computer or server. In the case involving a remote computer, the remote computer may be connected to the user computer through any kind of network, including a local area network (LAN) or a wide area network (WAN), or may be connected to an external computer (e.g., via an Internet connection using an Internet service provider).

The flowcharts and block diagrams in the drawings illustrate architectures, functions, and operations that may be implemented by systems, methods, and computer program products in accordance with various embodiments of the disclosure. In this regard, each block in a flowchart or block diagram may represent a module, program segment, or portion of code that contains one or more executable instructions for implementing a specified logical function. It should also be noted that, in some alternative implementations, the functions illustrated in the blocks may also occur in an order different from that illustrated in the drawings. For example, two successively represented blocks may actually be executed substantially in parallel, and they may sometimes be executed in a reverse order, depending on the functionality involved. It is also noted that each block of the block diagrams and/or flowcharts, and combinations of blocks in the block diagrams and/or flowcharts, may be implemented with a dedicated hardware-based system that performs the specified functions or operations, or may be implemented with a combination of dedicated hardware and computer instructions.

The described modules involved in the embodiments of the disclosure may be implemented by means of software or hardware. The described modules may also be provided in a processor, for example, may be described as: a processor including a generation module, a determination module and a sending module. Here, the names of these modules do not constitute limitations to such modules themselves in some cases. For example, the generation module may also be described as “a module configured to perform, in response to receiving target information sent by a user terminal for a plurality of candidate applications in a group chat, semantic analysis on the target information to generate a target task corresponding to the target information”.

The above descriptions are example embodiments of this disclosure and an explanation of the used technical principles. Those skilled in the art should understand that the scope of the embodiments of the disclosure is not limited to technical solutions formed by specific combinations of the aforementioned technical features, but should also cover other technical solutions formed by any combination of the aforementioned technical features or equivalent features without departing from the aforementioned embodiments. For example, the technical solution formed by replacing the above features with technical features having similar functions as those disclosed (but not limited to) in the disclosed embodiments.

What is claimed is:

1. A method for processing a task, the method comprising:
based on receiving target information sent by a user terminal for a plurality of candidate applications in a group chat, performing semantic analysis on the target information to generate a target task corresponding to the target information;
identifying, based on the target task and the plurality of candidate applications, a target application corresponding to the target task;
providing the target task to the target application, so that the target application executes the target task;
receiving task result information corresponding to the target task from the target application;
generating, based on the task result information, target response information corresponding to the task result information;
providing the target response information corresponding to the task result information on the user terminal.

2. The method according to claim 1, wherein the identifying the target application corresponding to the target task comprises:
identifying whether a task type of the target task is a preset type;
based on identifying that the task type of the target task is the preset type, matching the target task with application information of the plurality of candidate applications to obtain a matching result; and
identifying, based on the matching result, at least one target application corresponding to the target task from the plurality of candidate applications.

3. The method according to claim 1, wherein the providing the target task to the target application comprises:
acquiring a user identification corresponding to the user terminal;
performing, based on permission information corresponding to the target application, permission verification on the user identification, to obtain a verification result of the user identification; and
based on identifying that the verification result represents the user identification having permission, providing the target task to the target application.

4. The method according to claim 3, wherein the method further comprises:
based on identifying that the verification result represents the user identification having no permission, generating permission restriction information corresponding to the target task based on the permission information of the target application; and
providing the permission restriction information on the user terminal.

5. The method according to claim 1, wherein the method further comprises:
based on receiving permission setting information for a target terminal in the group chat, identifying a sending terminal corresponding to the permission setting information; and
based on identifying that the sending terminal has setting permission, setting permission restriction information of the target terminal based on the permission setting information.

6. The method according to claim 1, wherein the generating the target response information corresponding to the task result information comprises:
acquiring current environment information and a user identification corresponding to the user terminal;
identifying portrait information corresponding to the target information, based on the user identification and the current environment information; and
generating the target response information corresponding to the task result information, based on the portrait information corresponding to the target information.

7. The method according to claim 1, wherein the method further comprises:
based on identifying that a device is activated, acquiring application information of the plurality of candidate applications;
creating a to-be-enabled group chat based on the application information of the plurality of candidate applications, and generating group chat information corresponding to the to-be-enabled group chat; and
based on receiving an access operation sent by the user terminal based on the group chat information, joining the user terminal to the group chat.

8. The method according to claim 7, wherein the method further comprises:
based on receiving an access operation of a new terminal, identifying whether the access operation of the new terminal meets an access condition; and
based on identifying that the access operation of the new terminal meets the access condition, joining the new terminal to the group chat.

9. The method according to claim 1, wherein the method further comprises:
based on receiving an add operation of the user terminal in the group chat, acquiring application information of a to-be-added application corresponding to the add operation;
installing the to-be-added application based on the application information of the to-be-added application; and
adding the application information of the to-be-added application to the group chat.

10. The method according to claim 1, wherein the method further comprises:
based on receiving a deletion operation of the user terminal in the group chat, acquiring application information of a to-be-deleted application corresponding to the deletion operation;
uninstalling the to-be-deleted application based on the application information of the to-be-deleted application; and
removing the application information of the to-be-deleted application from the group chat.

11. The method according to claim 1, wherein the performing the semantic analysis on the target information to generate the target task corresponding to the target information comprises:
based on receiving a plurality pieces of target information sent by a plurality of user terminals for the plurality of candidate applications in the group chat, performing semantic analysis on the plurality pieces of target information to generate a plurality of target tasks corresponding to the plurality pieces of target information,
wherein the identifying the target application corresponding to the target task comprises:
sorting the plurality of target tasks according to pre-prioritization to obtain a task list; and
identifying the target application corresponding to each target task successively, according to a sort sequence of the plurality of target tasks in the task list, and
wherein the sending the target task to the target application comprises:
after processing of a target task is completed, providing a next target task to the corresponding target application, according to the sort sequence of the plurality of target tasks in the task list.

12. The method according to claim 1, wherein the method further comprises:
based on acquiring application notification information corresponding to the plurality of candidate applications, generating push information corresponding to the application notification information, based on a portrait information corresponding to the user terminal; and
providing the push information on the user terminal.

13. An apparatus for processing a task, the apparatus comprising:
at least one memory configured to store instructions;
at least one processor configured to execute the instructions to control the apparatus to:
based on receiving target information sent by a user terminal for a plurality of candidate applications in a group chat, perform semantic analysis on the target information to generate a target task corresponding to the target information;
identify a target application corresponding to the target task, based on the target task and the plurality of candidate applications;
provide the target task to the target application, so that the target application executes the target task;
receive task result information corresponding to the target task from the target application;
generate, based on the task result information, target response information corresponding to the task result information; and
provide the target response information corresponding to the task result information on the user terminal.

14. The apparatus of claim 13, wherein the at least one processor is further configured to execute the instructions to control the apparatus to:
identify whether a task type of the target task is a preset type;
based on identifying that the task type of the target task is the preset type, match the target task with application information of the plurality of candidate applications to obtain a matching result; and
identify, based on the matching result, at least one target application corresponding to the target task from the plurality of candidate applications.

15. The apparatus of claim 13, wherein the at least one processor is further configured to execute the instructions to control the apparatus to:
acquire a user identification corresponding to the user terminal;
perform, based on permission information corresponding to the target application, permission verification on the user identification, to obtain a verification result of the user identification; and
based on identifying that the verification result represents the user identification having permission, provide the target task to the target application.

16. The apparatus of claim 13, wherein the at least one processor is further configured to execute the instructions to control the apparatus to:
based on identifying that the verification result represents the user identification having no permission, generating permission restriction information corresponding to the target task based on the permission information of the target application; and
providing the permission restriction information on the user terminal.

17. The apparatus of claim 13, wherein the at least one processor is further configured to execute the instructions to control the apparatus to:
based on receiving permission setting information for a target terminal in the group chat, identifying a sending terminal corresponding to the permission setting information; and
based on identifying that the sending terminal has setting permission, setting permission restriction information of the target terminal based on the permission setting information.

18. The apparatus of claim 13, wherein the at least one processor is further configured to execute the instructions to control the apparatus to:
acquire current environment information and a user identification corresponding to the user terminal;
identify portrait information corresponding to the target information, based on the user identification and the current environment information; and
generate the target response information corresponding to the task result information, based on the portrait information corresponding to the target information.

19. An electronic device, comprising:
at least one processor; and
at least one memory communicatively connected to the at least one processor,
wherein the at least one memory is configured to store instructions that, when executed by the at least one processor, cause the electronic device to perform a method comprising:
based on receiving target information sent by a user terminal for a plurality of candidate applications in a group chat, performing semantic analysis on the target information to generate a target task corresponding to the target information;
identifying, based on the target task and the plurality of candidate applications, a target application corresponding to the target task;
providing the target task to the target application, so that the target application executes the target task;
receiving task result information corresponding to the target task from the target application;
generating, based on the task result information, target response information corresponding to the task result information;
providing the target response information corresponding to the task result information on the user terminal.

20. A non-transitory computer readable recording medium comprising instructions that, when executed, performs a method comprising:
based on receiving target information sent by a user terminal for a plurality of candidate applications in a group chat, semantic analysis on the target information to generate a target task corresponding to the target information;
determining, based on the target task and the plurality of candidate applications, a target application corresponding to the target task;
providing the target task to the target application, so that the target application executes the target task;
receiving task result information corresponding to the target task from the target application;
generating, based on the task result information, target response information corresponding to the task result information; and
providing the target response information corresponding to the task result information on the user terminal.
